(19) United States
(12) Patent Application Publication
(10) Pub. No.: US 2026/0337029 A1
(43) Pub. Date: Oct. 29, 2026

(54) Graphite from Sustainable Sources and Method for Making Same

(71) Applicant: BIRLA CARBON U.S.A., INC., Marietta, GA (US)

(72) Inventors: Michael J. Regula, Marietta, GA (US); Zachary Combs, Marietta, GA (US)

(21) Appl. No.: 19/103,909

(22) PCT Filed: Aug. 17, 2023
(86) PCT No.: PCT/US2023/030445

§ 371 Date: Feb. 14, 2025

Related U.S. Application Data
(60) Provisional application No. 63/399,047, filed on Aug. 18, 2022.

(51) Int. Cl. C01B 32/205; C10B 55/00; H01M 4/583; H01M 4/62; H01M 10/0525; H01M 10/0567

(52) U.S. Cl. CPC C01B 32/205; C10B 55/00; H01M 4/583; H01M 4/625; H01M 10/0525; H01M 10/0567; C01P 2002/60; C01P 2002/72; C01P 2004/51

(57) ABSTRACT

Graphite prepared from renewable or sustainable source feedstock, methods for making same, and batteries comprising same.

### CROSS-REFERENCE TO RELATED APPLICATIONS

This application claims priority to U.S. Provisional Application No. 63/399,047, filed Aug. 18, 2022, the entirety of which is incorporated into this application by reference.

### BACKGROUND

The demand for lithium-ion battery materials is expected to increase significantly over the next decade largely due to the expected increase in demand for electric vehicles.

Meeting that demand will require not only a scale up in current materials production methods, but also the development of new ways to produce these materials.

Graphite is the most common anode material in lithium-ion batteries. There are two types of graphite: synthetic and natural. Synthetic graphite is traditionally produced by graphitizing petroleum cokes, while natural graphite is mined and then purified using various processes. There is a need in the art for processes capable of efficiently preparing graphite from renewable, recyclable, or sustainable resources.

### SUMMARY

Most carbonaceous materials treated at high temperatures but without catalysts will only carbonize to form disordered, amorphous carbon materials or ordered soft carbon materials with cross-linked domains or ordered soft carbon materials with graphitic domains. See Sagues, et al., “A simple method for producing bio-based anode materials for lithium-ion batteries,” Green Chem., 2020, 22, 7093. The inventors surprisingly discovered a method of graphitizing a feedstock derived from a renewable and sustainable feedstock without the use of a coking, calcination, or graphitization catalyst.

One embodiment of the non-catalytic graphitization method comprises (a) providing a feedstock comprising at least one aromatic compound, the feedstock being derived from a sustainable or renewable source; (b) coking the feedstock at a temperature ranging from 300 °C to 650 °C to provide a coke; (c) calcining the coke at a temperature ranging from 900 °C to 1500 °C to provide a calcined coke; and (d) graphitizing the calcined coke at a temperature ranging from 2200 °C to 3200 °C.

Also described is graphite prepared by the disclosed non-catalytic graphitization method. Also described is graphite, independent of the disclosed graphitization method, which is characterized by an interlayer distance spacing of 002 planes (d₀₀₂) ranging from 0.335 nm to 0.338 nm and a crystallite size in the direction of the c-axis (L_{c}) ranging from 20 nm to 45 nm.

Also described are lithium ion batteries having an anode comprising graphite prepared by a disclosed graphitization method or having the above characteristics regardless of how the material was graphitized, along with a cathode, and an electrolyte disposed between the anode and the cathode.

### BRIEF DESCRIPTION OF THE DRAWINGS

The foregoing summary, as well as the following description of the disclosure, is better understood when read in conjunction with the appended drawings. For the purpose of illustrating the disclosure, the drawings illustrate some, but not all, alternative embodiments. This disclosure is not limited to the precise arrangements and instrumentalities shown. The following figures, which are incorporated into and constitute part of the specification, assist in explaining the principles of the disclosure.

FIG. 1 shows plots demonstrating the graphitization process from a feedstock which was a residue from a biomass pyrolysis process.

FIG. 2 shows overlaid powder x-ray diffraction patterns of the bio-graphite, in comparison to the pattern from Birla Carbon's synthetic graphite, BCG18.

FIG. 3 shows a photograph of an embodiment of the milled and powdered bio-graphite prepared according to the disclosed method.

FIG. 4 shows a particle size distribution graph of an embodiment of the bio-graphite.

FIG. 5 shows electrochemical data obtained from a cell utilizing the bio-graphite as part of the anode material.

FIG. 6 is a plot of voltage versus specific capacity, which demonstrates that the bio-graphite demonstrated expected lithium intercalation chemistry of typical graphites. See, e.g., Allart et al., “Model of Lithium Intercalation into Graphite by Potentiometric Analysis with Equilibrium and Entropy Change Curves of Graphite Electrode,” Journal of the Electrochemical Society, 165 (2) A380-A387 (2018).

FIG. 7 shows electrochemical data from NMC532 full cells (coin cells) that were built with the bio-graphite.

FIG. 8 shows additional data gathered from the NMC532 bio-graphite full cell coin cells, which show an impressive rate performance, including a 70.8% capacity retention at 2 C.

FIG. 9 is a plot showing results from further electrochemical testing of NMC811 full cells, showing a first cycle coulombic efficiency of 78.5%. A cell utilizing a reference non-bio-graphite is shown at the right of the plot.

### DETAILED DESCRIPTION

In one aspect, the method of producing graphite comprises providing a feedstock comprising at least one aromatic compound, the feedstock being derived from a sustainable or renewable source; coking the feedstock at a temperature ranging from 300 °C to 650 °C to provide a coke; calcining the coke at a temperature ranging from 900 °C to 1500 °C to provide a calcined coke; and graphitizing the calcined coke at temperature ranging from 2200 °C to 3200 °C. The process in some aspects does not involved the use of any catalyst in any part of the process, including the calcination and graphitization steps.

A “sustainable or renewable source” refers to resources that can be sustained or renewed, e.g., naturally or otherwise replenished, recycled, and the like, such that the source will not eventually be entirely depleted. Examples include biomass, oils from biomass, manufactured materials such as plastics, among others.

In one aspect, the coking step can be performed at a temperature ranging from 300 °C to 650 °C to provide the coke. In a further aspect, the coking step can be performed at a temperature ranging from 400 °C to 600 °C. In a further aspect, the coking step can be performed at a temperature ranging from 450 °C to 500 °C. In a further aspect, the coking step can be performed at a temperature of about 500 °C. When the term “about” precedes a numerical value here and elsewhere in this application, the value can vary plus or minus 10% unless specified otherwise. In one specific aspect, the coking step can be performed at a temperature of about 500 °C for about five hours in an inert atmosphere such as nitrogen. As discussed above, the coking step can be performed without any catalyst including an aromatization catalyst.

The coke can generally be calcined at a temperature ranging from 900 °C to 1500 °C to provide the calcined coke. In one aspect, the coke can be calcined at a temperature ranging from 1000 °C to 1400 °C. In a further aspect, the coke can be calcined at a temperature ranging from 1100 °C to 1300 °C. In a further aspect, the coke can be calcined at a temperature of about 1200 °C, for example in a furnace under an inert gas such as nitrogen. As discussed above, the calcining step can be performed without any catalyst including an aromatization catalyst.

The calcined coke can generally be graphitized at temperature ranging from 2200 °C to 3200 °C. In one aspect, calcined coke can be graphitized at temperature ranging from 2300 °C to 3100 °C. In a further aspect, the calcined coke can be graphitized at temperature ranging from 2400 °C to 3000 °C. In a further aspect, the calcined coke can be graphitized at temperature ranging from 2500 °C to 2900 °C. In a further aspect, the calcined coke can be graphitized at temperature ranging from 2600 °C to 2800 °C. In a further aspect, the calcined coke can be graphitized at temperature of about 2700 °C, e.g., in a furnace under an inert atmosphere such as helium.

In one aspect, the feedstock comprises residual oil remaining from a process that comprises the step of pyrolyzing biomass to recover at least one of benzene, toluene, or xylene from an aromatized fraction of the pyrolyzed biomass. The oil or bio-oil can in one aspect be derived by subjecting a biomass feed stream in the presence of a cracking catalyst to yield a vaporous fraction of hydrocarbons. The vaporous fraction can be separated from other oxygen containing organic compounds and the cracking catalyst, after which the vaporous fraction can be converted to a product that includes aromatic compounds, e.g., using an aromatization catalyst such as a zeolite catalyst. Desired aromatic compounds can then be removed, leaving behind a bio-oil residue. This bio-oil residue can in some aspects be the feedstock of the disclosed graphitization method. Although the feedstock can be pyrolyzed or aromatized with a catalyst, it should be understood that embodiments of the method to graphitize the feedstock do not involve the use of any catalyst.

Biomass pyrolysis methods for preparing and recovering aromatic compounds, particularly benzene, toluene, and xylene, are described further in U.S. Patent Publication No. 2017/0247617A1, to Schenk et al. Similar plastic pyrolysis methods for preparing similar aromatic compounds are described in U.S. Patent Publication No. 2022/0195310A1, also to Schenk et al. Both the '617 and '310 patent publications are incorporated into this application by reference in their entireties, for their teachings of pyrolysis methods that leave behind a bio-oil or other residue suitable for use as the sustainable or renewable feedstock for the disclosed graphitization methods.

As will be further understand with reference to the '617 application, in some aspects, the biomass for the pyrolysis method can be lignocellulosic biomass, such as plants or wood including soft woods such as pine. In a further aspect, the biomass for the pyrolysis method can comprise agricultural waste, plants, wood, or a combination thereof.

The inventors surprisingly discovered that a bio-oil derived from residue remaining from the biomass pyrolysis processes described above results in a bio-oil having a degree and character of aromaticity such that a catalyst such (e.g., an aromatization catalyst) is not needed to further aromatize the bio-oil feedstock or otherwise catalyze either the calcination or graphitization steps. In some aspects, the at least one aromatic compound in the feedstock constitutes at least 60% by weight of the feedstock, e.g., at least 65%, at least 70%, at least 75%, at least 80%, at least 85%, at least 90%, or at least 95% or a higher by weight amount of the feedstock is one or more aromatic compounds.

In one aspect, the feedstock comprises at least one of xylene, toluene, o-xylene, trimethylbenzene, benzene, naphthalene, ethylbenzene, or indene. In a further aspect, the feedstock comprises one or more of xylene, toluene, or benzene. In a still further aspect, the feedstock comprises xylene, toluene, and benzene. In another aspect, the feedstock comprises at least one of xylene, toluene, o-xylene, trimethylbenzene, benzene, naphthalene, ethylbenzene, or indene, where xylene is present in the feedstock in an amount of up to 80% by weight of the feedstock, toluene up to 80% by weight, o-xylene up to 25% by weight, trimethylbenzene up to 25% by weight, benzene up to 80% by weight, naphthalene up to 25% by weight, ethylbenzene up to 25% by weight, and indene up to 5% by weight. The feedstock can also comprise other aromatic or non-aromatic compounds. In one aspect, the feedstock is a liquid or an oil at 25 °C.

In one aspect, the feedstock is free of anthracene. In another aspect, the feedstock is free of methylated anthracenes. In a further aspect, the feedstock is free of aromatic oxygenates. In a further aspect, the coke prepared from the feedstock is free of anthracene. In another aspect, the coke prepared from the feedstock is free of methylated anthracenes. In a further aspect, the coke prepared from the feedstock is free of aromatic oxygenates. In another aspect, the calcined coke is free of anthracene. In a further aspect, the calcined coke is free of methylated anthracenes. In a further aspect, the calcined coke is free of aromatic oxygenates. In some aspects, these aromatic species can form with traditional graphitization processes that utilize certain aromatization catalysts.

Also disclosed is graphite prepared by any of the disclosed methods. In one aspect, the graphite is “bio-graphite,” which refers to graphite derived from biogenic carbon such as biomass. In one aspect, the graphite prepared by the graphitization method is characterized by an interlayer distance spacing of 002 planes (d₀₀₂) ranging from 0.335 nm to 0.338 nm and a crystallite size in the direction of the c-axis (L_{c}) ranging from 20 nm to 45 nm. In a further aspect, the graphite prepared by the graphitization method has a charge capacity greater than 315 mAh/g, e.g., greater than 320 mAh/g, greater than 325 mAh/g, or greater than 330 mAh/g.

Also disclosed are lithium-ion batteries (LiBs) having an anode comprising graphite prepared by the disclosed graphitization method, a cathode, and an electrolyte disposed between the anode and the cathode. In one aspect, the electrolyte comprises a vinylene carbonate additive. In a further aspect, the LiB is capable of achieving a first cycle coulombic efficiency of at least 90% at a charge capacity greater than 330 mAh/g.

Also disclosed, independently of any disclosed graphitization method, is graphite derived from a sustainable or renewable feedstock, the graphite characterized by an interlayer distance spacing of 002 planes (d₀₀₂) ranging from 0.335 nm to 0.338 nm and a crystallite size in the direction of the c-axis (L_{c}) ranging from 20 nm to 45 nm. In one aspect, the graphite has a charge capacity greater than 315 mAh/g. In a further aspect, the graphite is derived from biomass. In a further aspect, the graphite is derived from lignocellulosic biomass. Also disclosed are lithium ion batteries (LiBs) having an anode comprising graphite derived from a sustainable or renewable feedstock and having the interlayer distance and crystallite size of the c-axis, along with a cathode and an electrolyte disposed between the anode and the cathode. In one aspect, the electrolyte comprises a vinylene carbonate additive.

### A. Examples

The following examples further illustrate this disclosure. The scope of the disclosure and claims is not limited by the scope of the following examples.

Residual oil from a biomass pyrolysis process, which was a liquid oil at room temperature and included a mixture of aromatic compounds, including one or more of xylene, toluene, o-xylene, trimethylbenzene, benzene, naphthalene, ethyl benzene, and indene, was first coked in a ceramic boat in a tube furnace at 500 °C for five hours under nitrogen. The resulting coke was calcined at 1200 °C under nitrogen in a furnace. The calcine coke was graphitized at 2700 °C under helium in a furnace to prepare the bio-graphite.

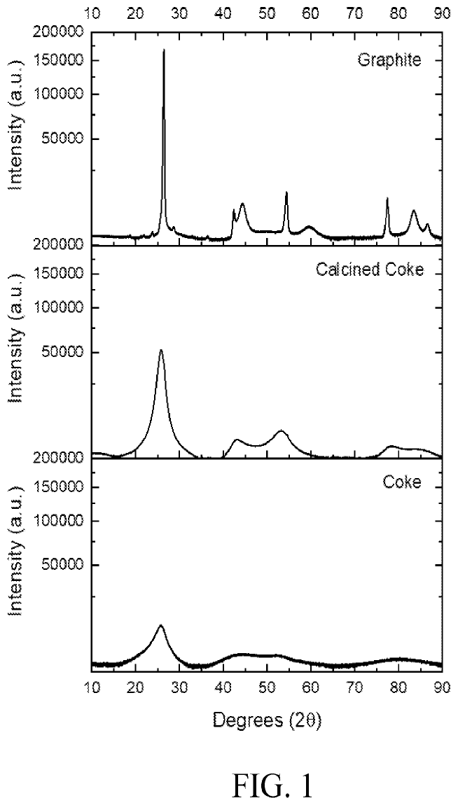

Graphitization of the coke was evidence from the x-ray diffraction data shown in FIG. 1. Yields from the calcination and graphitization are shown in Table 1. (002) d-spacing and L_{c} data are shown in Table 2, with reference to BCG18, a synthetic graphite produced by Birla Carbon (Marietta, GA, USA).

TABLE 1

| Step | Starting Mass (g) | Ending Mass (g) | Yield (%) |
|---|---|---|---|
| Coking | — | 18.6 | — |
| Calcination | 18.6 | 17.3 | 93.0 |
| Graphitization | 17.3 | 17.2 | 99.4 |

TABLE 2

| | | | Bio-Calcined | Bio- | |
|---|---|---|---|---|---|
| Property | Unit | Bio-Coke | Coke | Graphite | BCG18 |
| (002) d-spacing | nm | 0.3455 | 0.3471 | 0.3370 | 0.3365 |
| L_{c} | nm | 2.6 | 2.6 | 28.9 | 41.4 |

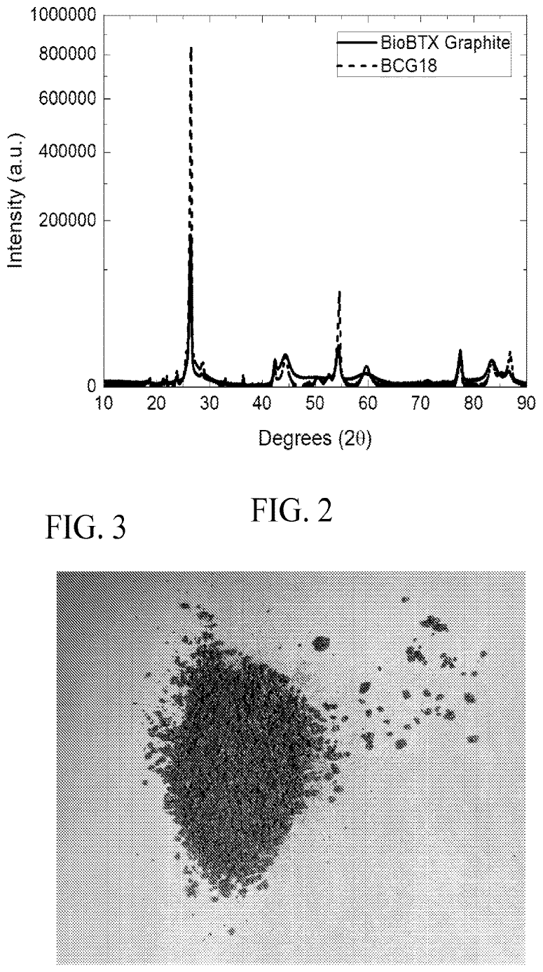

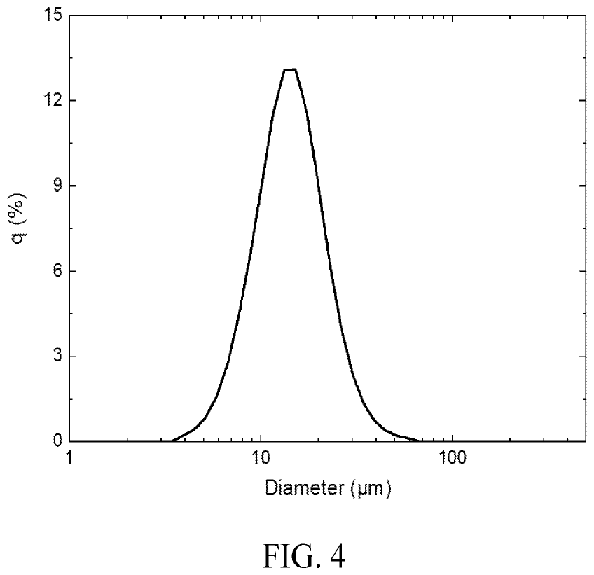

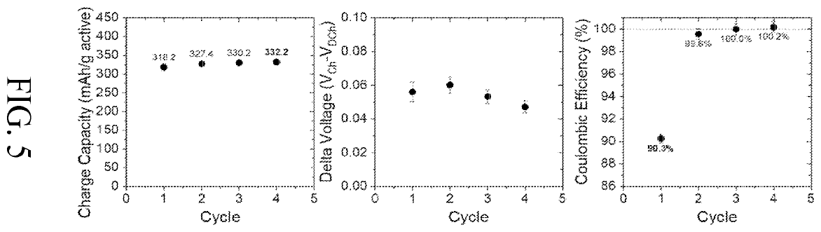

Powder x-ray diffraction patterns of the bio-graphite, in comparison to the pattern from Birla's BCG18 are shown in FIG. 2. A photograph of the milled and powdered bio-graphite is shown in FIG. 3. Particle size of the bio-graphite was similar to a typical battery-grade graphite. A particle size distribution graph is shown in FIG. 4. Particle size distribution data in addition to specific capacity and first cycle coulombic efficiency data achieved with the bio-graphite in an electrochemical half cell are shown in Table 3.

TABLE 3

| Properties | Unit | Bio-Graphite |
|---|---|---|
| D_{V}10 | μm | 7.6 |
| D_{V}50 | μm | 13.1 |
| D_{V}90 | μm | 22.5 |
| 1st Cycle Discharge Capacity | mAh/g | 332 |
| 1st Cycle Coulombic Efficiency | % | 90.3 |

As shown in Table 3, the bio-graphite from the biomass pyrolysis residue achieved a capacity of 332 mAh/g and a first cycle coulombic efficiency of 90.3%. Additional electrochemical data are shown in FIG. 5. By comparison, a bio-graphite made using catalytic graphitization achieved a specific capacity of 335 mAh/g, but only a 68.5% first cycle coulombic efficiency. Carbon coating the catalytically produced bio-graphite improved the first cycle coulombic efficiency to 87.9%, but reduced the specific capacity to 301 mAg/g. The relatively low first cycle coulombic efficiency of the uncoated bio-graphite is most likely due to the relatively small particle size that the material was milled to. This property was significantly improved by increasing the particle size using carbon coating but it could alternatively be done by optimizing the milling parameters where the graphite achieves a 10-20 micron DV₅₀ without carbo-coating. Carbon coating would primarily be done to increase conductivity, though coulombic efficiency benefits may be gained as well from the increase in particle size. In general, specific capacity should also increase as temperature at which the bio-calcined coke is graphitized. Degree of graphitization and specific capacity are directly correlated.

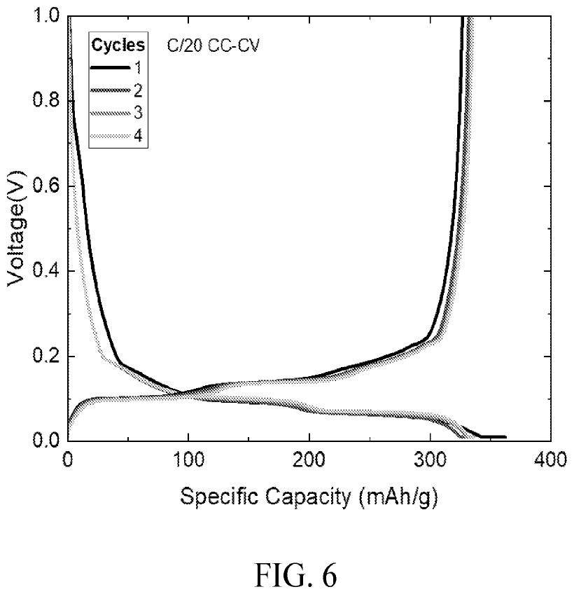

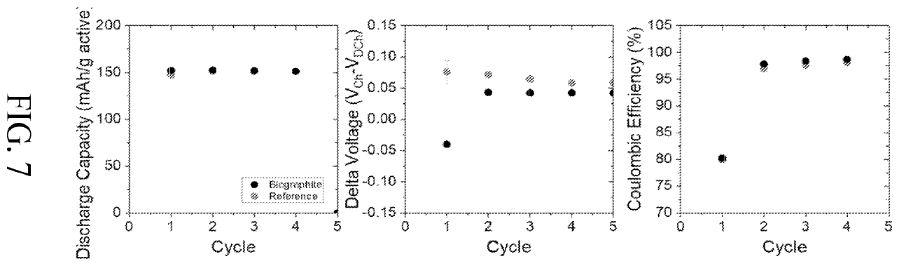

The bio-graphite prepared according to an embodiment of the disclosed method demonstrated expected lithium intercalation chemistry of graphites typically used in lithium batteries, as shown in FIG. 6.

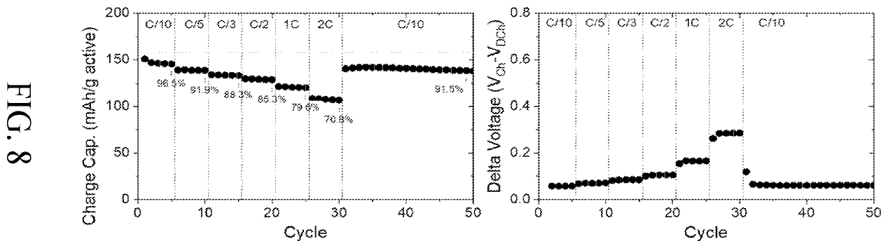

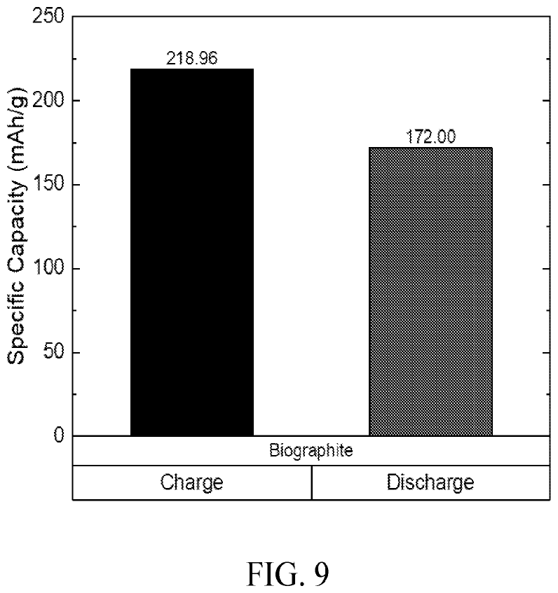

NMC532 full cells (coin cells) were built with the bio-graphite, and electrochemical data from these cells are shown in FIG. 7. The NMC532 bio-graphite full cell coin cells exhibited impressive rate performance, including a 70.8% capacity retention at 2 C, as shown in FIG. 8. Further electrochemical testing showed the bio-graphite's excellent performance as an anode material, as shown in FIG. 9. It is believed that the bio-graphite's performance as an anode material may be further improved by using an electrolyte that contains vinylene carbonate as an additive.

Features and advantages of this disclosure are apparent from the detailed specification, and the claims cover all such features and advantages. Numerous variations will occur to those skilled in the art, and any variations equivalent to those described in this disclosure fall within the scope of this disclosure. Those skilled in the art will appreciate that the conception upon which this disclosure is based may be used as a basis for designing other methods and systems for carrying out the several purposes of this disclosure. As a result, the claims should not be considered as limited by the description or examples.

What is claimed is:

1. A method for producing graphite, comprising:
a) providing a feedstock comprising at least one aromatic compound, the feedstock being derived from a sustainable or renewable source;
b) coking the feedstock at a temperature ranging from 300 °C to 650 °C to provide a coke;
c) calcining the coke at a temperature ranging from 900 °C to 1500 °C to provide a calcined coke; and
d) graphitizing the calcined coke at temperature ranging from 2200 °C to 3200 °C;
wherein the method does not involve the use of a calcination or graphitization catalyst.

2. The method of claim 1, wherein the feedstock comprises residual oil remaining from a process that comprises the step of pyrolyzing biomass to recover at least one of benzene, toluene, or xylene from an aromatized fraction thereof.

3. The method of claim 2, wherein the biomass is lignocellulosic biomass.

4. The method of claim 2, wherein the biomass comprises agricultural waste, plants, wood, or a combination thereof.

5. The method of claim 1, wherein the feedstock is free of anthracene.

6. The method of claim 1, wherein the feedstock is free of methylated anthracenes.

7. The method of claim 1, wherein the feedstock is free of aromatic oxygenates.

8. The method of claim 1, wherein the at least one aromatic compound constitutes at least 60% by weight of the feedstock.

9. The method of claim 1, wherein the feedstock comprises at least one of xylene, toluene, o-xylene, trimethylbenzene, benzene, naphthalene, ethylbenzene, or indene.

10. The method of claim 1, wherein the feedstock is a liquid or an oil at 25 °C.

11. Graphite prepared by the method of claim 1.

12. A lithium-ion battery (LiB) having an anode comprising graphite of claim 1, a cathode, and an electrolyte disposed between the anode and the cathode.

13. The battery of claim 12, wherein the electrolyte comprises a vinylene carbonate additive.

14. Graphite derived from a sustainable or renewable feedstock, the graphite characterized by an interlayer distance spacing of 002 planes (d₀₀₂) ranging from 0.335 nm to 0.338 nm and a crystallite size in the direction of the c-axis (Lₑ) ranging from 20 nm to 45 nm.

15. The graphite of claim 14, which has a charge capacity greater than 315 mAh/g.

16. The graphite of claim 14, which is derived from biomass.

17. The graphite of claim 16, which is derived from lignocellulosic biomass.

18. A lithium-ion battery (LiB) having an anode comprising graphite of claim 14, a cathode, and an electrolyte disposed between the anode and the cathode.

19. The battery of claim 18, wherein the electrolyte comprises a vinylene carbonate additive.
